(19) United States
(12) Patent Application Publication
(10) Pub. No.: US 2021/0358258 A1
(43) Pub. Date: Nov. 18, 2021

(54) DEVICE COMPONENT DISTRIBUTION

(71) Applicant: Hewlett-Packard Development Company, L.P., Spring, TX (US)

(72) Inventors: Gerold Keith Shelton, Boise, ID (US); Kyle J. Nottingham, Boise, ID (US); Matthew Frederickson, Spring, TX (US)

(73) Assignee: Hewlett-Packard Development Company, L.P., Spring, TX (US)

(21) Appl. No.: 17/262,291

(22) PCT Filed: Jan. 30, 2019
(86) PCT No.: PCT/US2019/015787

§ 371 Date: Jan. 22, 2021

(51) Int. Cl. G07F 11/62; B65G 1/137; G07C 9/00; G07C 9/22

(52) U.S. Cl. CPC G07F 11/62; G07C 9/22; G07C 9/00912; B65G 1/137

(57) ABSTRACT

Examples associated with device component distribution are described. One example apparatus includes a set of receptacles for storing electronic devices. The apparatus also includes a rotary distribution compartment to store components associated with the electronic devices. The apparatus also includes an apparatus controller. The apparatus controller includes an authentication module to authenticate a user based on a credential provided by the user. The apparatus controller also includes a distribution module. The distribution module grants the user access to a member of the set of receptacles storing an assigned device to be provided to the user. The distribution module also controls the rotary distribution compartment to dispense components associated with the assigned device.

### BACKGROUND

Computing devices today have become a fundamental part of the way we live and work, as well as smaller and more mobile than past devices. Individuals, for example, use computers and mobile devices for entertainment, communication, shopping, and so forth. Further, businesses often provide computers for their employees so that the employees can efficiently carry out their duties across a wide variety of functions. While some businesses take on ownership and maintenance of devices provided to their users, other companies may opt to offload certain information technology costs using a variety of techniques. For example, some companies may rely on a device-as-a-service (DAAS) offering. A DAAS offering may involve periodic payments to a device provider in exchange for user devices and service guarantees for the hardware, software, and so forth, of the devices. In some examples, the DAAS offering may also include certain device components such as cables and external peripherals.

### BRIEF DESCRIPTION OF THE DRAWINGS

The present application may be more fully appreciated in connection with the following detailed description taken in conjunction with the accompanying drawings.

FIG. 1 illustrates an example service kiosk associated with device component distribution.

FIG. 2 illustrates an example apparatus associated with device component distribution.

FIG. 3 illustrates another example service kiosk associated with device component distribution.

FIG. 4 illustrates a flowchart of example operations associated with device component distribution.

FIG. 5 illustrates another flowchart of example operations associated with device component distribution.

FIG. 6 illustrates an example computing device in which example systems, and methods, and equivalents, may operate.

### DETAILED DESCRIPTION

Examples associated with device component distribution are described. As will be more fully described herein, a service kiosk is an apparatus that is meant to store a set of devices for supporting a device-as-a-service model. The service kiosk includes a set of compartments fitted with connectors to provide a connection between a device stored within the compartment and various modules embedded in the service kiosk. The service kiosk may be physically installed in a location accessible to employees of a company relying on a device-as-a-service model to provide electronic devices to its employees. When service events associated with devices occur, the employees may visit the kiosk to have their device repaired by the kiosk and/or replaced by backup devices stored in the kiosk. This may increase the uptime of devices assigned to the employees. The backup devices may also reduce support costs associated with sending out technicians to provide support as a device failure can be at least temporarily mitigated by replacing the failed device with a new device in the kiosk, until eventually, a technician can be sent out to efficiently service or replace many devices stored in the kiosk in a single visit.

In some examples, it may be desirable to distribute device components in addition to devices themselves. These device components may be, for example, components such as cables that are used to ensure device functionality, peripherals that add additional functionality to a device, and so forth. While in some examples, it may be appropriate to store components within receptacles with the devices they are intended to support, in other examples, it may not be known when a device is placed into a receptacle which additional components will be used by the ultimate user of the device. Consequently, an additional distribution mechanism may be built into a service kiosk to facilitate distribution of these additional components. In some examples, the additional distribution mechanism may operate akin to a rotary distribution mechanism of a vending machine that turns a coil to distribute products stored in the vending machine. In other examples, the service kiosk may also include mechanisms for tracking distribution and return of components provided to users along with devices. These may include scanners for identifying components as they are distributed and returned, storage compartments for storing returned components, and so forth.

It is appreciated that, in the following description, numerous specific details are set forth to provide a thorough understanding of the examples. However, it is appreciated that the examples may be practiced without limitation to these specific details. In other instances, methods and structures may not be described in detail to avoid unnecessarily obscuring the description of the examples. Also, the examples may be used in combination with each other.

“Module”, as used herein, includes but is not limited to hardware, instructions stored on a computer-readable medium or in execution on a machine, and/or combinations of each to perform a function(s) or an action(s), and/or to cause a function or action from another module, method, and/or system. A module may include a microprocessor controlled via instructions executable by the microprocessor, a discrete module, an analog circuit, a digital circuit, a programmed module device, a memory device containing instructions, and so on. Modules may include gates, combinations of gates, or other circuit components. Where multiple logical modules are described, it may be possible to incorporate the multiple logical modules into one physical module. Similarly, where a single logical module is described, it may be possible to distribute that single logical module between multiple physical modules.

As used herein, a service kiosk is intended to broadly describe a category of apparatuses used to securely store electronic devices in a manner that allows the devices to be configured while stored in the service kiosk. The service kiosk may have one or more compartments having data and/or power connectors. Devices that are attached to the data connectors may be configured either directly by the service kiosk or remotely by a remote service. Depending on where the devices are in their life cycle, the configuration may include setting up a device for a new user, modifying the device on behalf of a current user (e.g., reconfiguring the device, repairing the device), deprovisioning a device, and so forth. The service kiosk may also include an interface for communicating with and/or authenticating users. Once authenticated, the service kiosk may grant the user access to devices and or compartments to allow the user to perform tasks involving the compartments and devices stored therein including tasks related to devices assigned to that user. These tasks may involve obtaining a device from the kiosk, storing a device in the kiosk, and so forth. In various examples, the service kiosk may resemble, for example, a vending machine, a set of lockers, a chest of drawers, and so forth. Various structural components of a service kiosk may be made from wood, metal, plastic, or other suitable materials. The service kiosk may include structural elements such as legs, supports, wall fasteners, and so forth.

Consequently, the service kiosk may facilitate fulfilling service guarantees of a device-as-a-service (DAAS) offering. In a DAAS offering, a user or business may periodically pay a device provider for a device and a promise to service the device in the event the device fails. The service guarantee may include a variety of terms and in various examples may cover firmware, software, hardware, device data, user data, periodic lifecycle upgrades, and so forth. In this example, ownership of the device may remain with the device provider. In the event of a failure of the device or some other technical issue related to the device, a service kiosk stationed in a location accessible to the user may allow the device provider to more easily provide technical support for the device, up to and including replacing the device with a working device. For businesses that are relying on several devices at any given time, it may be cost effective for the business to have an on-site service kiosk to be able to quickly provision a new device for a new user, deprovision a device when that device's user leaves the business, and so forth, in addition to the technical support features that may be facilitated by the service kiosk itself. Eventually, when it is determined that the state of the devices in the service kiosk make it likely the service kiosk will begin failing to fulfil the service guarantee to the business (e.g., because the service kiosk is full, empty, has a number of devices in need of repair, or a combination of factors) a technician may be called to service the kiosk and/or devices stored within. This may be less expensive to the business and/or the device provider than having a technician on site, or having a technician called to service each malfunctioning device.

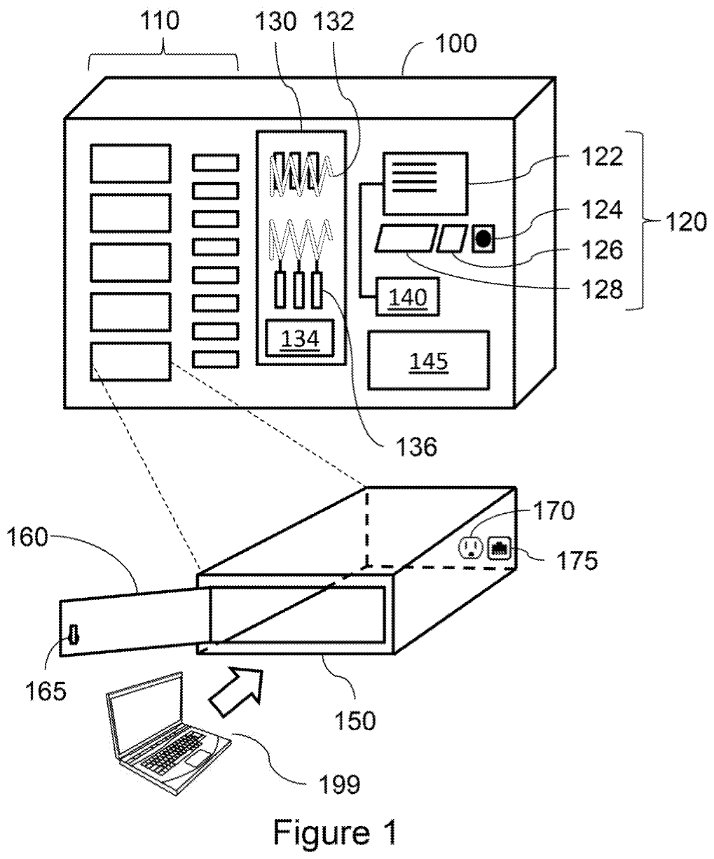

FIG. 1 illustrates an example service kiosk 100 associated with device component distribution. Service kiosk 100 includes a set of receptacles 110. While 13 receptacles are shown, in other examples, service kiosk 100 may include a greater or lesser number of receptacles. The receptacles 110 may be adapted for storing electronic devices 199. Different receptacles may be adapted to store different types of electronic devices 199. Here for example, larger receptacles 110 may be adapted to store a first type of device (e.g., laptops), and smaller receptacles 110 may be adapted to store a second type of device (e.g., cell phones). In other examples, receptacles may be configured to store different types, models, and/or brands of laptops, phones, tablets, or other device types. Receptacles 110 may be adapted to store different types of devices based on a variety of attributes. For example, receptacles 110 for storing phones may be smaller than receptacles 110 for storing laptops.

One receptacle 150 is illustrated in additional detail to further illustrate features of receptacles 110. In this example, receptacle 150 is adapted for storing laptops 199. This may affect the size of receptacle 150, connectors 170 and 175 installed in receptacle 150, and so forth. Here, receptacle 150 is shown as having an American style power connector 170 and an ethernet port 175. Power connector 170 may provide power to device 199, and ethernet port 175 may provide a data connection between device 199 and other components of service kiosk 100. For other types of devices, receptacles 110 may use a different configuration of connectors for providing power and/or data to a device 199. For example, a different regional power adaptor may be used for providing power to devices depending on a country in which service kiosk 100 is situated, a USB port may facilitate provision of both power and data to certain device types, and so forth.

It is also worth observing that in other examples, connectors may take different physical forms. For example, as connectors 170 and 175 are illustrated as being built into the rear wall of receptacle 150, it may also be appropriate to provide corresponding cables to connect device 199 to the connectors. In other examples, the connectors may be cables or retractable cables of the appropriate type for connecting to a device type for which receptacle 150 is configured, a docking port of a type appropriate for connecting to a device type for which receptacle 150 is configured, a wireless communication transmitter (e.g., WIFI, Bluetooth) and so forth. The different connector types may have different tradeoffs. For example, the ports as illustrated may ensure that a device appropriate cable is provided to a user who obtains a device from receptacle 150 but would also mean that a user inserting a device 199 would have to bring or be provided such a cable. Alternatively, a connector that involves an installed cable or docking port may ensure that a person inserting a device into receptacle 150 would be able to insert the device without providing an additional cable but would mean that a user retrieving a device from receptacle 150 would have to be provided an appropriate cable through an alternative method.

Receptacle 150 also includes a locking mechanism 165. In this example, locking mechanism 165 is illustrated as being attached to a door 160 of receptacle 150. However, locking mechanism 165 may take a variety of forms and its form may depend on the form by which door 160 is designed to give access to users. Here for example, door 160 is illustrated as opening outwards, though in other examples, a sliding, rotating, or retracting door may be appropriate. Locking mechanism 165 may be controllable by other components of service kiosk 100 to grant and restrict access to receptacle 150. These other components and the situations in which access to receptacle 150 may be controlled are more fully discussed below. In some examples, it may also be desirable for locking mechanism 165 to be controllable via a physical mechanism (e.g., a service key). This may allow receptacle 150 to be serviced by a technician to, for example, modify the contents of receptacle 150, repair a component of receptacle 150, and so forth, even when service kiosk 100 is unpowered.

Service kiosk 100 also includes an interface 120. Interface 120 may include several components. Here interface 120 includes a display 122, a keyboard 128, a keypad 126, and a radio frequency identification (RFID) scanner 124. Interface 120 may use these components to facilitate communicating with user interacting with service kiosk 100. Interface 120 may also include additional components including for example, cameras, touch input devices, external device connectors (e.g., to provide power and/or data to devices not in receptacles 110), and so forth. Interface 120 may also make use of lights associated with individual receptacles 110. These lights may allow the interface to direct a user to a specific receptacle 110 of service kiosk 100. For example, when service kiosk 100 seeks to direct a user to a specific receptacle 110, service kiosk 100 may control a light on that receptacle to turn on, blink, and so forth.

Service kiosk 100 may also include a kiosk controller 140 that incorporates a variety of modules 140 for performing various functions associated with service kiosk 100 and/or configuring devices 199 stored in compartments 110 of service kiosk 100. Kiosk controller 140 may be, for example, performed by a processor of a computer embedded in service kiosk 100. In other examples, the kiosk controller may act as a communication pass through for communications between a remote information technology module (e.g., a device-as-a-service operation) and devices 199 stored in compartments 110 of service kiosk 100.

In various examples, the kiosk controller 140 may interact with a user via interface 120, with devices 199 in compartments 110, and with remote servers and/or devices. For example, kiosk controller 140 may include an authentication module. The authentication module may receive a credential from a user and authenticate the credential based on authentication data associated with the user. The authentication data may have been received from a remote information technology module. When the user is successfully authenticated, the authentication module or another module of service kiosk 100 may grant the user access to one or more receptacles 110 of service kiosk 100. The user may provide the credential via user interface 120. The credential may be, for example, a username and password pair that identifies the user that the user inputs via keyboard 128. In another example, the credential may be an RFID signal the user provides via RFID scanner 124. In another example, the user may authenticate themselves by attaching the mobile device 199 to a data connector of service kiosk 100. Multi-factor authentication may also be appropriate involving a combination of the above and/or other authentication techniques.

Service kiosk 100 also includes a component distribution compartment 130. Component distribution compartment 130 may facilitate distributing additional components 136 with devices 199 that are not stored in receptacles 110. These components 136 may include, for examples, cables a user might need to provide power and/or data connections for their device, peripherals the user might find useful, other components that may improve the functionality of device 199 (e.g., extra sticks of memory), security tools, and so forth. Peripherals may include input/output devices such as mice, keyboards, docks, headphones, speakers, microphones, webcams, and so forth. The peripherals might also include specialized tools associated with a specific role or function associated with the user. In this example, component distribution compartment 130 is illustrated as relying on a rotary distribution mechanism 132. Here rotary distribution mechanism 132 is illustrated as a set of coils in which components 136 are situated and/or are hanging from. While the coils are illustrated as operating parallel to the length of service kiosk 100, in other examples, the coils may be facing towards the front of service kiosk 100 akin to how certain vending machines organize and distribute snacks. As mentioned above, components 136 may be situated within the coils so that they fall into, for example, a drop tray, when brought to the front of the coils by rotating the coils. The drop tray may be accessible via a slot 134 that is also designed to prevent users from accessing undistributed components when open. In various examples, the coils may be situated in trays to prevent components 136 from falling out of the coils prior to their intended distribution. In other examples, components 136 may hang from coils either from hangars built into components 136, hangars built into packaging of components 136, hangers affixed to components 136 or packaging thereof, and so forth. Here rotating the coils may cause components 136 to fall when its hangar reaches the end of the coil. In the above example, components may be retrieved from component distribution compartment via rotary distribution mechanism 132.

In some examples service kiosk 100 also includes a storage compartment 145. Storage compartment 145 may facilitate returning components 136, device 199, and so forth to service kiosk 100. This may allow returned components to be retrieved by, for example, a technician when servicing service kiosk 100 for either return to component distribution compartment 130, repackaging, repair, and so forth. In various examples, service kiosk 100 may also facilitate tracking components by scanning components as they are distributed. This may be achieved by, for example, a scanner 124 (e.g., an RFID scanner, a barcode scanner, a NFC scanner) and so forth and a corresponding tag on the components. Components and/or devices may be scanned both when a user is retrieving devices from service kiosk 100 and/or returning devices to service kiosk 100.

In various examples, service kiosk 100 may be selective about granting user access to receptacles 110. How service kiosk 100 determines which receptacles 110 to which a user is granted access may depend on what function service kiosk 100 is performing for the user. In various examples, the user may be picking up a device from service kiosk 100, storing a device in service kiosk 100, having a device repaired or configured by service kiosk 100, diagnosing a technical issue with a device with the help of service kiosk 100, and so forth. In these examples, service kiosk 100 may grant such a user access only to receptacles associated with the task being performed by service kiosk 100. The user may be granted access to these receptacles 110 by service kiosk 100 controlling locking mechanisms 165 on the respective receptacles 110. In cases where the user is a technician responsible for servicing service kiosk 100, the user may be granted access to specific receptacles, or in some cases general access to all receptacles 110. This may allow the technician to adjust the contents of the receptacles and/or perform physical maintenance on devices stored within service kiosk 100 or on service kiosk 100 itself.

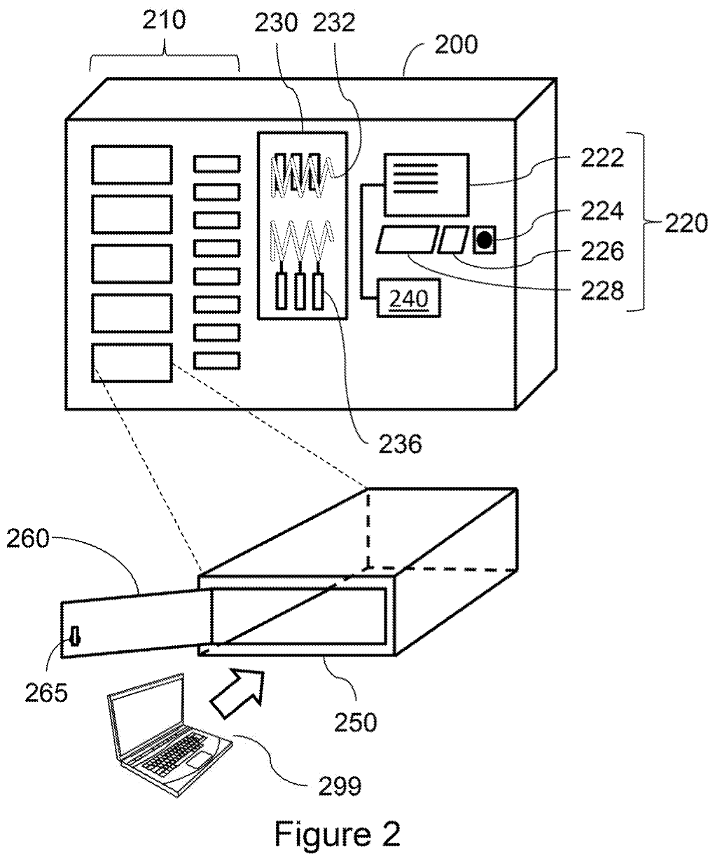

FIG. 2 illustrates an apparatus 200. Apparatus 200 includes a set of receptacles 210. Members of the set of receptacles 210 may store electronic devices 299. In this example, apparatus 200 includes receptacles 210 of two different sizes. This may reflect that apparatus 200 may store different types of electronic devices. For example, larger receptacles 210 may be adapted for storing laptops, and smaller receptacles 210 may be adapted for storing cellular phones. In other examples, other types of electronic devices may be stored in receptacles 210. In various examples, each member of the set of receptacles may include a power connector, a data connector, a locking mechanism, and so forth.

Apparatus 200 also includes a rotary distribution compartment 230. Rotary distribution compartment 230 may store components 236 associated with electronic devices 299. In various examples, rotary distribution compartment may store components 236 for distribution using rotating coils 232 that distribute components 236 by rotating the coils 232 to cause the components 236 to fall into a distribution receptacle (not shown). This may be similar to the manner by which certain types of vending machines distribute snacks or other products. In various examples, the components 236 associated with the electronic devices may include, for example, cables, peripherals, and so forth associated with electronic devices 299. The cables may be, for example, coiled and stored in the rotary using, for example, respective cable storage straps. The cable storage straps may also include hangars to facilitate hanging the cables from coils 232, and encoded tags that facilitate tracking cables assigned to the specific user. For example, the encoded tags may be RFID tags, tags having a bar code or QR code printed thereon, and so forth. As discussed above, the components 236 may be seated within the coils 232, hanging from the coils 232, and so forth.

Apparatus 200 also includes an apparatus controller 240. Apparatus controller 200 may be able to control components of apparatus 200 including for example, user interface 220, rotary distribution mechanisms, and parts of receptacles such as power connectors, data connectors, and locking mechanisms. Apparatus controller 240 may include an authentication module. The authentication module may authenticate a user based on a credential provided by the user. The credential may be provided by the user to the authentication module via a user interface 220 of apparatus 200. In this example, apparatus 200 includes a display 222 for providing information to users, and a keyboard 228, a number pad 226, and a scanner 224 (e.g., an RFID scanner) for receiving information from users.

Apparatus controller 240 may also include a distribution module. The distribution module may grant the user access to a member of the set of receptacles (e.g., receptacle 250). The member of the set of receptacles 250 may store an assigned device 299 to be provided to the user. For example, the distribution module may control a locking mechanism 265 on a door 260 of receptacle 250 to grant the user access to device 299. The distribution module may also control rotary distribution compartment 230 to dispense components associated with the assigned device. The components associated with the assigned devices may be provided based on, for example, a device type of the assigned device, a user profile, and so forth. For example, cables distributed to a user may be distributed so that they have connectors that work with the device provided to the user, peripherals may be distributed to the user based on data retrieved from that user's profile (e.g., based on specific peripherals to be provided to the user, based on a work function associated with the user), and so forth.

In some examples, apparatus controller 240 may include a provisioning module. The provisioning module may configure assigned device 299 for the user based on a user profile. The user profile may be received from a remote information technology module. Configuring the device may include, for example, installing applications on the device, storing user data on the device, setting up user configurations on the device based on user configurations of a prior device allocated to the user, and so forth.

In some examples, apparatus 200 may include a storage receptacle (not shown). The storage receptacle may store returned component. In this example, apparatus controller 240 may include a return module. The return module may facilitate scanning an encoded tag associated with a returned component, and update a database based on the returned component. By way of illustration, after providing a component to a user, a user profile associated with the user may be tagged to indicate that the user is in possession of that device. By scanning an encoded tag on that component when it is returned to apparatus 200, the user profile may be updated to indicate the user is no longer in possession of that component.

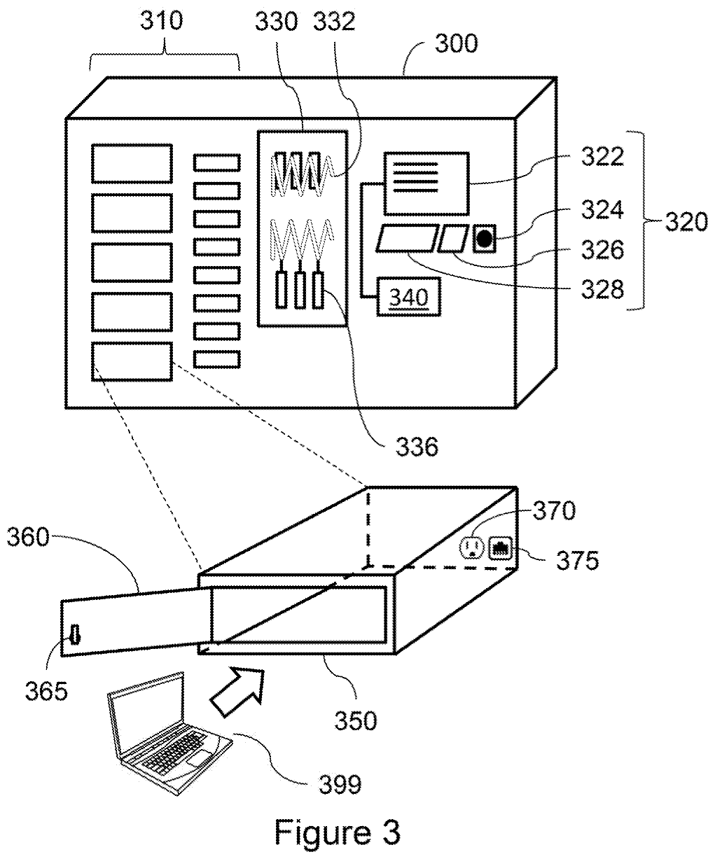

FIG. 3 illustrates a service kiosk 300. Service kiosk 300 include a set of receptacles 310. Members of the set of receptacles (e.g., receptacle 350) may be adapted to store electronic devices 399. Here receptacles are shown having two sizes (a larger size and a smaller size) to illustrate that different receptacles may be adapted to store different types of electronic devices. Members of the set of receptacles may include respective power adaptors 370, respective data adaptors 375, and respective locking mechanisms 365. Here, locking mechanism 365 is illustrated as a latch for door 360 of receptacles 350, though other locking mechanisms may be used.

Service kiosk 300 also includes a component distribution mechanism 330. Component distribution mechanism 330 may facilitate distribution of components 336 for use in conjunction with the electronic devices. The components may be, for example, cables, peripherals, additional parts (e.g., RAM, storage), and so forth. The components 336 may be distributed via rotary mechanisms 332 that distribute components 336 similar to how certain types of vending machines distribute products such as snacks. For example, by rotating a coil, a component 336 may be dropped into a drop tray (not shown) and retrieved through a slot (not shown) built into component distribution mechanism 330.

Service kiosk 300 also includes a user interface 320. The user interface may allow a user to interact with service kiosk 300. In this example, user interface 300 includes a display 322, a keyboard 328, a keypad 326, and a scanner 324. Other user interface components may also be included.

Service kiosk 300 also includes a kiosk controller 340. Kiosk controller 340 may control components of service kiosk 300. Kiosk controller 340 may include an authentication module. The authentication module may authenticate the user based on information provided by the user via user interface 320. Kiosk controller 340 may also include a distribution module. The distribution module may grant the user access to a member of the set of receptacles 310 (e.g., receptacle 350). The member 350 of the set of receptacles 310 may store an assigned device 399 to be provided to the user. The distribution module may also control the component distribution compartment 330 to dispense components 336 to the user. Kiosk controller 340 may also include an instruction module. The instruction module may instruct the user, via user interface 320 through the process of retrieving assigned device 399 from receptacle 350, through performing an initial setup of assigned device 399, and so forth.

In some examples, the kiosk controller may also include a component tracking module. The component tracking module may track components provided to the user and components returned to a storage receptacle (not shown) of service kiosk 300. The component tracking module may track components by, for example, updating a database.

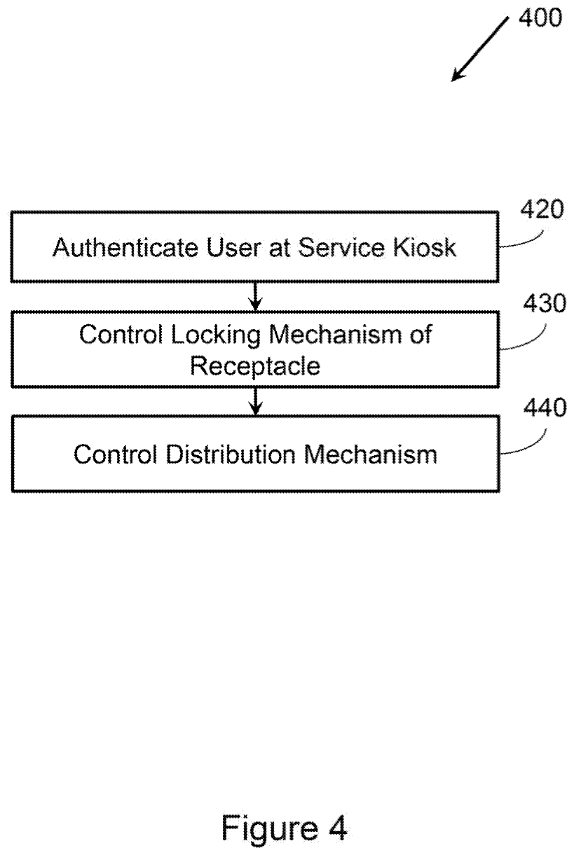

FIG. 4 illustrates an example method 400. Method 400 may be embodied on a non-transitory processor-readable medium storing processor-executable instructions. The instructions, when executed by a processor, may cause the processor to perform method 400. In other examples, method 200 may exist within logic gates and/or RAM of an application specific integrated circuit (ASIC).

Method 400 includes many actions associated with device component distribution. Method 400 includes authenticating a user at 420. The user may be authenticated at a service kiosk via an interface of the service kiosk. The interface may include, for example, a keyboard, a keypad, and so forth to allow the user to input a password, a scanner such as an RFID scanner, NFC scanner, biometric scanner, or barcode scanner to facilitate scanning an item in possession of the user and/or a biometric of the user.

Method 400 also includes controlling a locking mechanism on a receptacle of the service kiosk at 430. Controlling the locking mechanism may grant the user access to a device stored in the receptacle of the service kiosk. The device may be operably connected to the service kiosk via a connector that provides a data connection between the device and a service kiosk.

Method 400 also includes controlling a distribution mechanism of the service kiosk at 440. The distribution mechanism may be controlled to distribute a component associated with the device to the user. The components may be, for example, cables, extra parts, peripherals, security devices, and so forth. The components may be distributed by controlling a coil of the service kiosk to rotate causing a component closest to the end of the coil to be distributed to the user, and other components on the coil to advance towards the end of the coil.

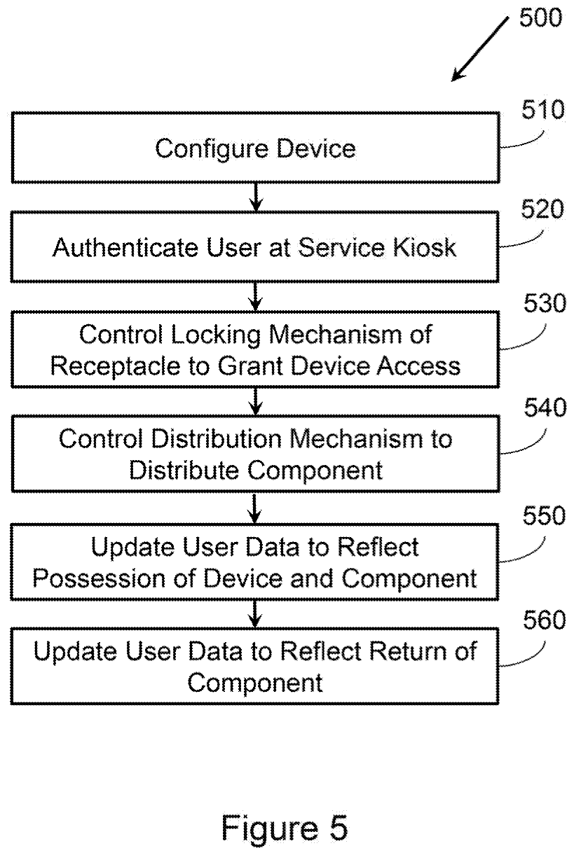

FIG. 5 illustrates a method 500 associated with device component distribution. Method 500 includes several actions similar to those described above with reference to method 400 (FIG. 4). For example, method 500 includes authenticating a user at a service kiosk 520, controlling a locking mechanism of a receptacle of the service kiosk at 530 to grant the user access to a device, and controlling a distribution mechanism of the service kiosk at 540.

Method 500 also includes configuring the device at 510. The device may be configured via a connection between the device and the service kiosk. The device may be configured based on user data. Configuring the device may include, for example, installing applications on the device, updating settings on the device based on past user preferences, installing user data on the device, and so forth.

Method 500 also includes updating the user data at 550. The user data may be updated to reflect possession of the device and the component associated with the device. Updating the user data may facilitate tracing which devices are in possession of the user so that they can later be retrieved, to facilitate performing updates and/or upgrades to the devices and/or components, and so forth.

Method 500 also includes updating the user data at 560. Here, the user data may be updated to reflect the user has returned a component to a storage compartment of the service kiosk. This may ensure that the user profile reflects the user is no longer in possession of the devices. Tracking devices in possession of users may also facilitate managing payments on the DAAS model. When a user or their company pays based on devices in possession of users, tracking devices and/or components in possession of users facilitate making sure the right charges are being processed for the right customers based on the level of service they are currently receiving. In various examples, the user may return components to a storage compartment built into the service kiosk.

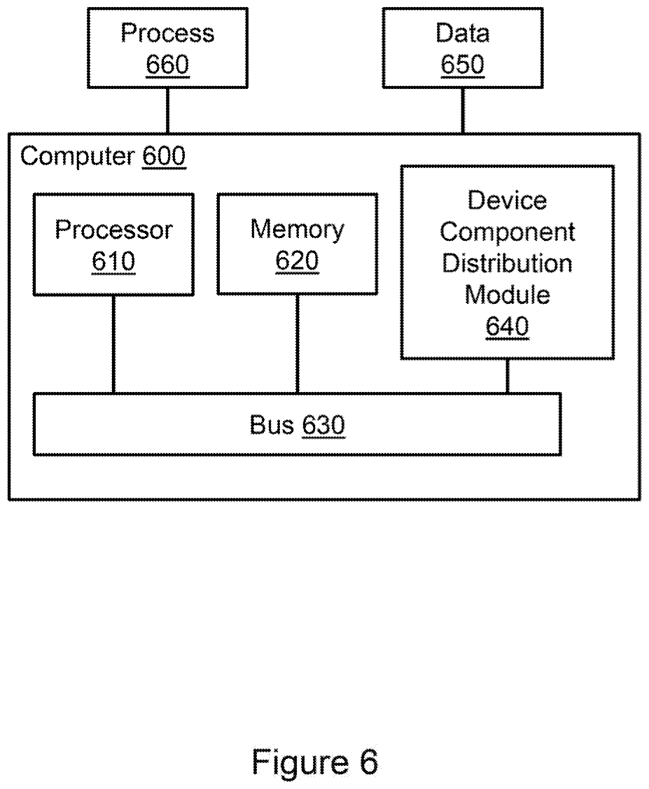

FIG. 6 illustrates an example computing device in which example systems and methods, and equivalents, may operate. The example computing device may be a computer 600 that includes a processor 610 and a memory 620 connected by a bus 630. Computer 600 includes a device component distribution 640. Device component distribution 640 may perform, alone or in combination, various functions described above with reference to the example systems, methods, and so forth. In different examples, Device component distribution 640 may be implemented as a non-transitory computer-readable medium storing processor-executable instructions, in hardware, as an application specific integrated circuit, and/or combinations thereof.

The instructions may also be presented to computer 600 as data 650 and/or process 660 that are temporarily stored in memory 620 and then executed by processor 610. The processor 610 may be a variety of processors including dual microprocessor and other multi-processor architectures. Memory 620 may include non-volatile memory (e.g., read-only memory, flash memory, memristor) and/or volatile memory (e.g., random access memory). Memory 620 may also be, for example, a magnetic disk drive, a solid-state disk drive, a floppy disk drive, a tape drive, a flash memory card, an optical disk, and so on. Thus, memory 620 may store process 660 and/or data 560. Computer 600 may also be associated with other devices including other computers, devices, peripherals, and so forth in numerous configurations (not shown).

It is appreciated that the previous description of the disclosed examples is provided to enable any person skilled in the art to make or use the present disclosure. Various modifications to these examples will be readily apparent to those skilled in the art, and the generic principles defined herein may be applied to other examples without departing from the scope of the disclosure. Thus, the present disclosure is not intended to be limited to the examples shown herein but is to be accorded the widest scope consistent with the principles and novel features disclosed herein.

What is claimed is:

1. An apparatus, comprising:
a set of receptacles for storing electronic devices;
a rotary distribution compartment to store components associated with the electronic devices;
a user interface; and
an apparatus controller comprising:
an authentication module to authenticate a user based on a credential provided by the user; and
a distribution module to grant the user access to a member of the set of receptacles storing an assigned device to be provided to the user, and to control the rotary distribution compartment to dispense components associated with the assigned device.

2. The apparatus of claim 1, where the components associated with the electronic devices include cables and peripherals associated with the electronic devices.

3. The apparatus of claim 2, where the cables are coiled and stored in the rotary using respective cable storage straps.

4. The apparatus of claim 3, where the cable storage straps include encoded tags that facilitate tracking cables assigned to the specific users.

5. The apparatus of claim 4, where the encoded tags are RFID tags.

6. The apparatus of claim 1, where the components associated with the assigned device are provided based on one of a device type of the assigned device and a user profile.

7. The apparatus of claim 1, where the apparatus controller comprises a provisioning module to configure the assigned device for the user by the user based on a user profile received from a remote information technology module.

8. The apparatus of claim 1, where each member of the set of receptacles includes a power connector, a data connector, and a locking mechanism, where the power connectors, data connectors, and locking mechanisms are controllable by the apparatus controller.

9. The apparatus of claim 1, comprising a storage receptacle for storing returned components, and where the apparatus controller comprises a return module to scan an encoded tag associated with a returned component, and to update a database based on the returned component.

10. A service kiosk, comprising:
a set of receptacles adapted to store electronic devices, where members of the set of receptacles include respective power adaptors, respective data adaptors, and respective locking mechanisms;
a component distribution mechanism to facilitate distribution of components for use in conjunction with the electronic devices;
a user interface to allow a user to interact with the service kiosk; and
a kiosk controller to control components of the service kiosk, the kiosk controller comprising:
an authentication module to authenticate the user based on information provided by the user via the user interface;
a distribution module to grant the user access to a member of the set of receptacles storing an assigned device to be provided to the user, and to control the component distribution compartment to dispense components to the user; and
an instruction module to instruct the user, via the user interface, through the process of retrieving the assigned device from a member of the set of receptacles, retrieving components from the component distribution mechanism, and performing an initial setup of the assigned device.

11. The service kiosk of claim 10, where the kiosk controller comprises a component tracking module to track components provided to the user and components returned to a storage receptacle of the service kiosk.

12. A method, comprising:
authenticating a user at a service kiosk via an interface of the service kiosk;
controlling a locking mechanism on a receptacle of the service kiosk to grant the user access to a device stored in the receptacle of the service kiosk, where the device is operably connected to the service kiosk via a connector that provides a data connection between the device and the service kiosk; and
controlling a distribution mechanism of the service kiosk to distribute to the user, a component associated with the device.

13. The method of claim 12, comprising configuring the device via the connection between the device and the service kiosk, where the device is configured based on user data.

14. The method of claim 13, comprising updating the user data to reflect user possession of the device and the component associated with the device.

15. The method of claim 14, comprising updating the user data to reflect the user has returned a component to a storage compartment of the service kiosk.
